(19) United States
(12) Patent Application Publication
(10) Pub. No.: US 2015/0061738 A1
(43) Pub. Date: Mar. 5, 2015

(54) CHARGE PUMP CIRCUIT

(71) Applicant: SAMSUNG ELECTRO-MECHANICS CO., LTD., Suwon-Si (KR)

(72) Inventors: Yong Il KWON, Suwon-Si (KR); Moon Suk JEONG, Suwon-Si (KR); Tah Joon PARK, Suwon-Si (KR)

(73) Assignee: SAMSUNG ELECTRO-MECHANICS CO., LTD., Suwon-Si (KR)

(21) Appl. No.: 14/231,198

(22) Filed: Mar. 31, 2014

(30) Foreign Application Priority Data
Aug. 27, 2013 (KR) 10-2013-0101720

(51) Int. Cl. H02M 3/07

(52) U.S. Cl. CPC H02M 3/07
USPC 327/157

(57) ABSTRACT

There is provided a charge pump circuit, including: a step-up circuit unit stepping up an input voltage at least once, according to a frequency and a voltage level of a clock signal; and a control unit altering the voltage level of the clock signal according to an output voltage from the step-up circuit unit to regulate the output voltage from the step-up circuit.

### CROSS-REFERENCE TO RELATED APPLICATION

This application claims the benefit of Korean Patent Application No. 10-2013-0101720 filed on Aug. 27, 2013, with the Korean Intellectual Property Office, the disclosure of which is incorporated herein by reference.

### BACKGROUND

The present disclosure relates to a charge pump circuit.

In general, a charge pump circuit is used for supplying voltage having a level higher than that supplied from a power source.

A charge pump circuit stores voltage from a power source in capacitors by alternately applying a first clock signal having a specific frequency (on the level of several MHz) and a second clock signal having a phase difference of 180 degrees with respect to the first clock signal, to generate a high voltage. More specifically, the charge pump circuit includes a plurality of transistors and stores the voltage from the power source in capacitors by switching the transistors on and off, according to the first and second clock signals, to output a high voltage.

Patent Document 1 below relates to an area-efficient charge pump circuit for system-on-glass (SoG) technology, and discloses reducing levels of ripple voltages using a cross-coupling structure and generating a regulated output voltage. However, Patent Document 1 is silent with respect to the problem in which an output voltage from a charge pump circuit is varied due to variations in a load current, i.e., variations in the resistance value of a load.

### RELATED ART DOCUMENT

(Patent Document 1) Korean Patent Laid-Open Publication No. 2005-0002785

### SUMMARY

An aspect of the present disclosure may provide a charge pump circuit that regulates an output voltage from a step-up circuit by altering the voltage level of a clock signal provided to the step-up circuit in accordance with the output voltage.

According to an aspect of the present disclosure, a charge pump circuit may include: a step-up circuit unit stepping up an input voltage at least once, according to a frequency and a voltage level of a clock signal; and a control unit altering the voltage level of the clock signal according to an output voltage from the step-up circuit unit to regulate the output voltage from the step-up circuit.

The control unit may include: a level-inverting unit altering a voltage level of a predetermined reference clock signal to generate the clock signal; a regulator providing a driving voltage to the level-inverting unit; and a comparison unit comparing the output voltage from the step-up circuit unit with a predetermined first reference voltage to control the regulator.

The level-inverting unit may include at least two inverters inverting the voltage level of the reference clock signal to output the inverted signal.

The regulator may alter a level of the driving voltage based on a comparison result from the comparison unit to be provided to the at least two inverters.

The control unit may further include an oscillator generating the reference clock signal.

The control unit may further include: a voltage-dividing unit dividing the output voltage from the step-up circuit unit to be provided to the comparison unit.

The comparison unit may include: a comparator comparing the output voltage from the step-up circuit unit with the predetermined first reference voltage; and a digital block generating a control signal for controlling the regulating based on the comparison result from the comparator.

The regulator may include: an operational amplifier including a non-inverting input terminal in which a predetermined second reference voltage is received; a first resistor connected between an output terminal and an inverting input terminal of the operational amplifier; and a second resistor connected between the inverting input terminal of the operational amplifier and ground.

At least one of resistance values of the first and second resistors may be altered according to the control signal.

The regulator may provide the voltage output from the operational amplifier to the level-inverting unit as a driving voltage.

The regulator may further include a capacitor connected between the output terminal of the operational amplifier and ground so as to regulate the voltage output from the operational amplifier.

According to another aspect of the present disclosure, a charge pump circuit may include: a step-up circuit unit including at least one step-up circuit that steps up an input voltage at least once, according to frequencies and voltage levels of two clock signals; and a control unit including a level-inverting unit that generates the two clock signals to alter a driving voltage provided to the level-inverting unit according to an output voltage from the step-up circuit unit, wherein the two clock signals have the same frequency and the same voltage level and a phase difference of 180 degrees.

The control unit may further include: a regulator providing a driving voltage to the level-inverting unit; and a comparison unit comparing the output voltage from the step-up circuit unit with a predetermined first reference voltage to control the regulator, wherein the level-inverting unit includes two inverters generating the two clock signals by inverting voltage levels of the two reference clock signals to output the inverted voltages.

The regulator may alter a level of the driving voltage based on a comparison result from the comparison unit to be provided to the at least two inverters.

The control unit may further include an oscillator generating the two reference clock signals.

The control unit may further include: a voltage-dividing unit dividing the output voltage from the step-up circuit unit to be provided to the comparison unit.

The comparison unit may include: a comparator comparing the output voltage from the step-up circuit unit with the predetermined first reference voltage; and a digital block generating a control signal for controlling the regulator based on the comparison result from the comparator.

The digital block may generate the control signal for decreasing the output voltage from the regulator when the output voltage is higher than the first reference voltage and may generate the control signal for increasing the output voltage from the regulator when the output voltage is lower than the first reference voltage.

The regulator may include: an operational amplifier including a non-inverting input terminal in which a predetermined second reference voltage is received; a first resistor connected between an output terminal and an inverting input terminal of the operational amplifier; and a second resistor connected between the inverting input terminal of the operational amplifier and ground.

At least one of resistance values of the first and second resistors may be altered according to the control signal.

The regulator may provide the voltage output from the operational amplifier to the level-inverting unit as a driving voltage.

The regulator may further include a capacitor connected between the output terminal of the operational amplifier and ground so as to regulate the voltage output from the operational amplifier.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a block diagram schematically illustrating a charge pump circuit according to an exemplary embodiment of the present disclosure;

FIG. 2 is a circuit diagram of the step-up circuit, an element of a charge pump circuit according to an exemplary embodiment of the present disclosure;

FIGS. 3 and 4 are circuit diagrams of a voltage-dividing unit, an element of a charge pump circuit according to an exemplary embodiment of the present disclosure;

FIG. 5 is a circuit diagram of the comparison unit, an element of a charge pump circuit according to an exemplary embodiment of the present disclosure;

FIG. 6 is a circuit diagram of the regulator, an element of a charge pump circuit according to an exemplary embodiment of the present disclosure; and

FIG. 7 is a circuit diagram of the level-inverting unit, an element of a charge pump circuit according to an exemplary embodiment of the present disclosure.

### DETAILED DESCRIPTION

Hereinafter, embodiments of the present disclosure will be described in detail with reference to the accompanying drawings. The disclosure may, however, be embodied in many different forms and should not be construed as being limited to the embodiments set forth herein. Rather, these embodiments are provided so that this disclosure will be thorough and complete, and will fully convey the scope of the disclosure to those skilled in the art. Throughout the drawings, the same or like reference numerals will be used to designate the same or like elements.

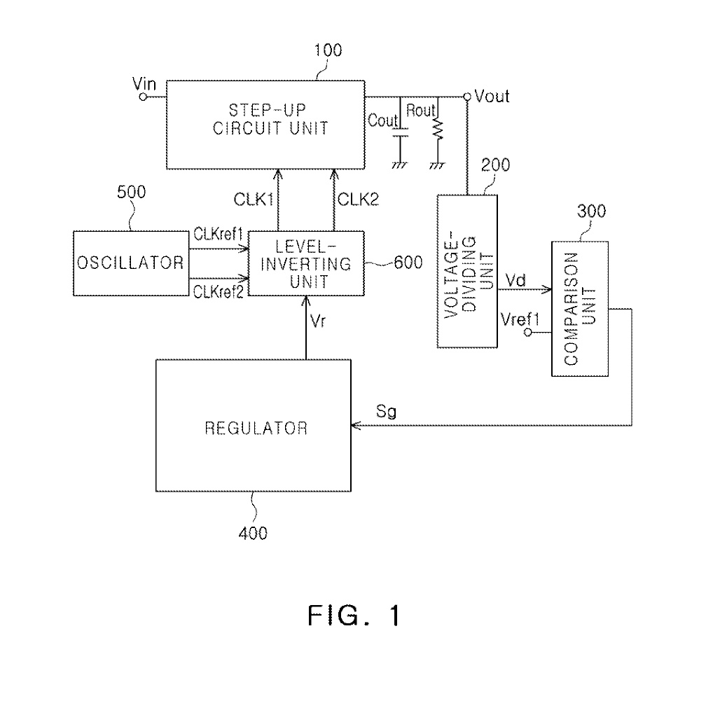

FIG. 1 is a block diagram schematically illustrating a charge pump circuit according to an exemplary embodiment of the present disclosure.

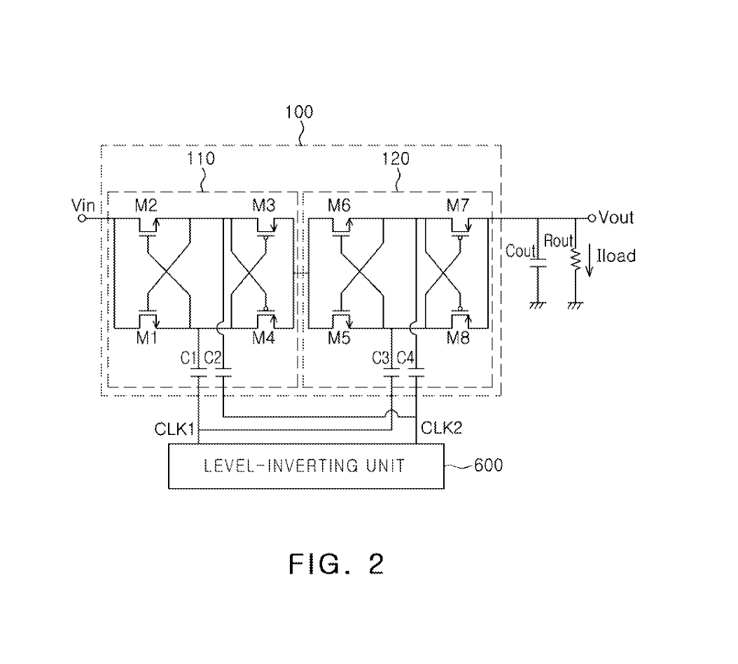

Referring to FIG. 1, the charge pump circuit according to the exemplary embodiment may include a step-up circuit unit 100, a comparison unit 300, a regulator 400, an oscillator 500, a level-inverting unit 600, as well as a voltage-dividing unit 200. Hereinafter, the configuration of a charge pump circuit according to exemplary embodiments of the present disclosure will be described in detail with reference to FIGS. 2 through 7.

FIG. 2 is a circuit diagram of the step-up circuit unit, an element of a charge pump circuit according to an exemplary embodiment of the present disclosure. Referring to FIG. 2, the step-up circuit unit 100 may include a first step-up unit 110 and a second step-up unit 120.

Although the step-up circuit unit 100 shown in FIG. 2 includes two step-up units 110 and 120, it is merely an example for convenience of illustration and it is apparent that the step-up circuit unit 100 according to the exemplary embodiment may include more than two step-up units. Hereinafter, for convenience of illustration, it is assumed that the step-up circuit unit 100 includes two step-up units 110 and 120.

A first step-up unit 110 may include n-type transistors M1 and M2, p-type transistors M3 and M4, and pumping capacitors C1 and C2. A second step-up unit 120 may include n-type transistors M5 and M6, p-type transistors M7 and M8, and pumping capacitors C3 and C4.

In the first step-up unit 110, the transistors M1 and M4 and the capacitor C1 may configure a pumping circuit, and the transistors M2 and M3 and the capacitor C2 may configure another pumping circuit.

A connection node between the gates of the transistors M1 and M4 may be connected to one terminal of the capacitor C2, and the source of the transistor M2 and the drain of the transistor M3 are connected to the one terminal of the capacitor C2.

A connection node between the gates of the transistors M2 and M3 may be connected to one terminal of the capacitor C1, and the source of the transistor M1 and the drain of the transistor M4 are connected to the one terminal of the capacitor C1.

A connection node between the drains of the transistors M1 and M2 may be connected to an input terminal to which an input voltage Vᵢₙ is applied. A connection node between the sources of the transistors M3 and M4 may be connected to the second step-up unit 120. At the other terminals of the capacitors C1 and C2, clock signals CLK1 and CLK2 may be received from the oscillator 600, respectively.

The clock signals CLK1 and CLK2 have the phase difference of 180 degrees and have the same frequency. When the clock signal CLK1 has a high level, the clock signal CLK2 has a low level and vice versa.

When the clock signal CLK1 has a high level while the clock signal CLK2 has a low level, the transistor M1 is turned off, the transistor M2 is turned on, the transistor M3 is turned off, and the transistor M4 is turned on. Accordingly, the input voltage Vin applied to the input terminal is stored in the capacitor C2 through the transistor M2, and the voltage stored in the capacitor C1 is released to the second step-up unit 120.

In addition, when the clock signal CLK1 is a low level while the clock signal CLK2 has a high level, the transistor M1 is turned on, the transistor M2 is turned off, the transistor M3 is turned on, and the transistor M4 is turned off. Accordingly, the input voltage Vᵢₙ applied to the input terminal is stored in the capacitor C1 through the transistor M1, and the voltage stored in the capacitor C2 is released to the second step-up unit 120.

The voltages released from the first step-up unit 110 to the second step-up unit 120 may have the same level as voltages that are obtained by subtracting the voltage levels of the clock signals CLK1 and CLK2 from the voltages stored in the capacitors C1 and C2, respectively.

The operation of the second step-up unit 120 is similar to that of the first step-up unit 110. A voltage Vₒᵤₜ generated in the second step-up unit 120 when clock signals are applied to be stored in a capacitor Cₒᵤₜ may be expressed by Mathematical expression 1 below:

Vₒᵤₜ=(1+2)*(Vᵢₙ−V_{CLK}) [Mathematical Expression 1]

Where the number two denotes the number of step-up units, and the term V_{CLK} denotes voltage level of clock signal.

As described above, the step-up circuit unit 100 according to the exemplary embodiment may include a plurality of step-up units (N step-up units). When the step-up circuit unit 100 includes a plurality of step-up units (N step-up units), Mathematical Expression 1 may be expanded as Mathematical Expression 2 below:

Vₒᵤₜ=(1+N)*(Vᵢₙ−V_{CLK}) [Mathematical Expression 2]

The level of the output voltage Vₒᵤₜ generated in the step-up circuit unit 100 may vary as a current I_{load} flowing through a load resistor Rout varies. According to the exemplary embodiment, in order to regulate the level of the output voltage Vₒᵤₜ, voltage levels of the clock signals CLK1 and CLK2 may be altered according to the level of the output voltage Vₒᵤₜ. This operation will be described below in detail.

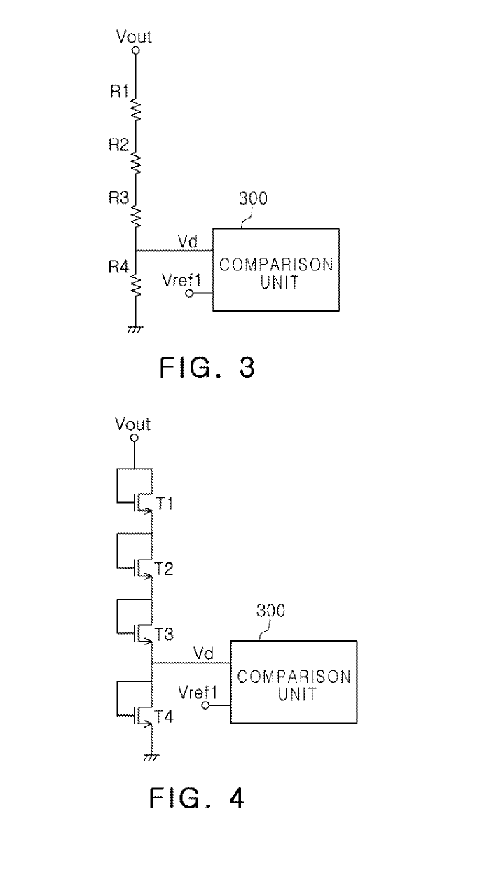

FIGS. 3 and 4 are circuit diagrams of a voltage-dividing unit, an element of a charge pump circuit according to an exemplary embodiment of the present disclosure. The voltage-dividing unit 200 may consist of at least two resistors such that it may generate divided voltage V_{d} that is determined by the ratio between resistance values of two resistors and may transmit the divided voltage V_{d} to the comparison unit 300.

The voltage-dividing unit 200 consists of four resistors R1, R2, R3 and R4 in FIG. 3, and the voltage-dividing unit 200 consists of four transistors T1, T2, T3 and T4 which are diode-connected in FIG. 4. However, these are merely examples and the number and type of the voltage-dividing unit 200 is not limited thereto.

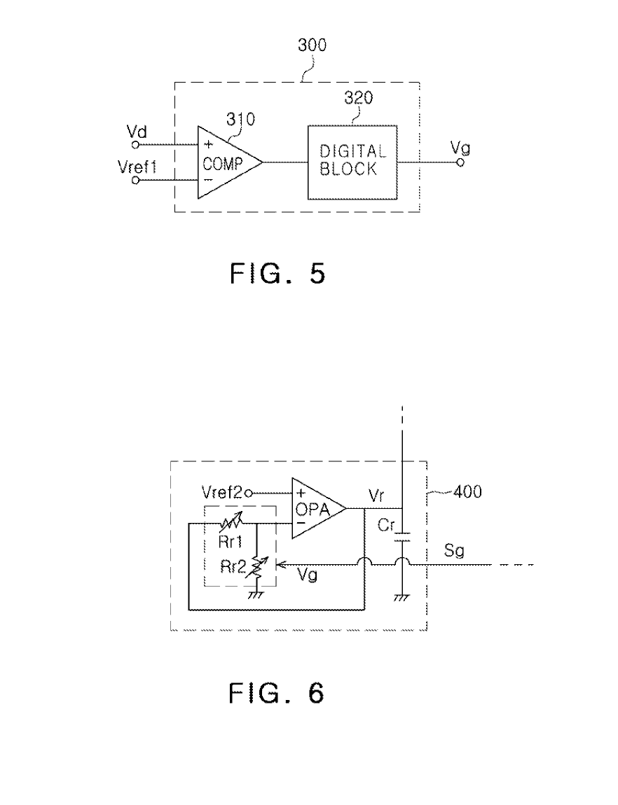

FIG. 5 is a circuit diagram of the comparison unit, an element of a charge pump circuit according to an exemplary embodiment of the present disclosure. The comparison unit 300 may include a comparator 310 and a digital block 320. The comparator 310 may compare a predetermined first reference voltage V_{ref1} with the divided voltage V_{d} from the voltage-dividing unit 300, and the digital block 320 may generate a control signal Sg for regulating the output voltage from the regulator 400 based on the comparison result.

That is, if it is determined from the comparison result that the output voltage Vₒᵤₜ is high, a control signal Sg for increasing the level of the voltage generated in the regulator 400 may be generated, and if it is determined from the comparison result that the output voltage Vₒᵤₜ is low, a control signal Sg for decreasing the level of the voltage generated in the regulator 400 may be generated.

FIG. 6 is a circuit diagram of the regulator, an element of a charge pump circuit according to an exemplary embodiment of the present disclosure. The regulator 400 may include an operational amplifier OPA, variable resistors Rr1 and Rr2, and a capacitor Cr. The operational amplifier OPA may include a non-inverting input terminal in which a predetermined second reference voltage V_{ref2} is received, and an inverting input terminal connected to a node between a terminal of the variable resistor Rr1 and a terminal of the variable resistor Rr2. The other terminal of the variable resistor Rr1 may be connected to the output terminal of the operational amplifier OPA, and the other terminal of the variable resistor Rr2 may be connected to ground. In addition, the capacitor Cr may be connected between the output terminal of the operational amplifier OPA and ground.

The voltage Vᵣ output from the operational amplifier is varied according to the ratio of resistance between the variable resistors to be applied to the inverting input terminal of the operational amplifier OPA. The operational amplifier OPA may compare the second predetermined reference voltage V_{ref2} with the voltage applied to the inverting input terminal of the operational amplifier to generate the output voltage Vᵣ. Here, the capacitor Cr may regulate the voltage Vᵣ output from the operational amplifier.

The resistance values of the variable resistors Rr1 and Rr2 may vary according to a control signal Sg output from the comparison unit 300. As described above, if it is determined from the comparison result from the comparison unit 300 that the output voltage Vₒᵤₜ is high, the resistance values of the variable resistors Rr1 and Rr2 are altered to increase the level of the voltage generated in the regulator 400, and if it is determined from the comparison result that the output voltage Vₒᵤₜ is low, the resistance values of the variable resistors Rr1 and Rr2 are altered to decrease the level of the voltage generated in the regulator 400.

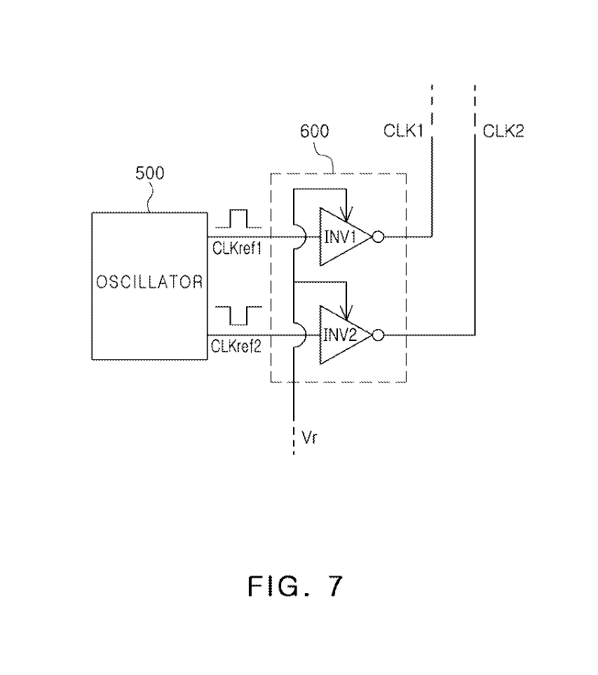

FIG. 7 is a circuit diagram of the level-inverting unit, an element of a charge pump circuit according to an exemplary embodiment of the present disclosure. Referring to FIG. 7, the level-inverting unit 600 may include at least two inverters INV1 and INV2. The inverters INV1 and INV2 may invert reference clock signals CLK_{ref1} and CLK_{ref2} provided from the oscillator 500 to generate clock signals CLK1 and CLK2. The reference clock signals CLK_{ref1} and CLK_{ref2} have the phase difference of 180 degrees with respect to the same frequency.

The voltage Vᵣ provided from the regulator 400 may be applied to the inverters INV1 and INV2 as a driving voltage, such that the inverters INV1 and INV2 may alter the voltage levels of the reference clock signals CLK_{ref1} and CLK_{ref2} provided from the oscillator 500 according to the voltage Vᵣ provided from the regulator 400.

That is, if the voltage level of the voltage Vᵣ provided from the regulator 400 is high, the reference clock signals CLKref1 and CLKref2 may be amplified by the inverters INV1 and INV2 to generate clock signals CLK1 and CLK2, respectively, and if the voltage level of the voltage Vᵣ provided from the regulator 400 is low, the reference clock signals CLKref1 and CLKref2 may be attenuated by the inverters INV1 and INV2 to generate clock signals CLK1 and CLK2, respectively.

As set forth above, according to exemplary embodiments of the present disclosure, an output voltage from a step-up circuit can be regulated by altering the voltage level of a clock signal provided to the step-up circuit in accordance with the output voltage.

While exemplary embodiments have been shown and described above, it will be apparent to those skilled in the art that modifications and variations could be made without departing from the spirit and scope of the present disclosure as defined by the appended claims.

What is claimed is:

1. A charge pump circuit, comprising:
a step-up circuit unit stepping up an input voltage at least once, according to a frequency and a voltage level of a clock signal; and
a control unit altering the voltage level of the clock signal according to an output voltage from the step-up circuit unit to regulate the output voltage from the step-up circuit.

2. The charge pump circuit of claim 1, wherein the control unit includes:
a level-inverting unit altering a voltage level of a predetermined reference clock signal to generate the clock signal;
a regulator providing a driving voltage to the level-inverting unit; and
a comparison unit comparing the output voltage from the step-up circuit unit with a predetermined first reference voltage to control the regulator.

3. The charge pump circuit of claim 2, wherein the level-inverting unit includes at least two inverters inverting the voltage level of the reference clock signal to output the inverted signal.

4. The charge pump circuit of claim 3, wherein the regulator alters a level of the driving voltage based on a comparison result from the comparison unit to be provided to the at least two inverters.

5. The charge pump circuit of claim 2, wherein the control unit further includes an oscillator generating the reference clock signal.

6. The charge pump circuit of claim 2, wherein the control unit further includes: a voltage-dividing unit dividing the output voltage from the step-up circuit unit to be provided to the comparison unit.

7. The charge pump circuit of claim 2, wherein the comparison unit includes: a comparator comparing the output voltage from the step-up circuit unit with the first reference voltage; and a digital block generating a control signal for controlling the regulating based on the comparison result from the comparator.

8. The charge pump circuit of claim 7, wherein the regulator includes:
an operational amplifier including a non-inverting input terminal in which a predetermined second reference voltage is received;
a first resistor connected between an output terminal and an inverting input terminal of the operational amplifier; and
a second resistor connected between the inverting input terminal of the operational amplifier and ground.

9. The charge pump circuit of claim 7, wherein at least one of resistance values of the first and second resistors is altered according to the control signal.

10. The charge pump circuit of claim 7, wherein the regulator provides the voltage output from the operational amplifier to the level-inverting unit as a driving voltage.

11. The charge pump circuit of claim 7, wherein the regulator further includes a capacitor connected between the output terminal of the operational amplifier and ground so as to regulate the voltage output from the operational amplifier.

12. A charge pump circuit, comprising:
a step-up circuit unit including at least one step-up circuit that steps up an input voltage at least once, according to frequencies and voltage levels of two clock signals; and
a control unit including a level-inverting unit that generates the two clock signals to alter a driving voltage provided to the level-inverting unit according to an output voltage from the step-up circuit unit,
wherein the two clock signals have the same frequency and the same voltage level and a phase difference of 180 degrees.

13. The charge pump circuit of claim 12, wherein the control unit further includes:
a regulator providing a driving voltage to the level-inverting unit; and
a comparison unit comparing the output voltage from the step-up circuit unit with a predetermined first reference voltage to control the regulator,
wherein the level-inverting unit includes two inverters generating the two clock signals by inverting voltage levels of the two reference clock signals to output the inverted voltages.

14. The charge pump circuit of claim 13, wherein the regulator alters a level of the driving voltage based on a comparison result from the comparison unit to be provided to the at least two inverters.

15. The charge pump circuit of claim 13, wherein the control unit further includes an oscillator generating the two reference clock signals.

16. The charge pump circuit of claim 13, wherein the control unit further includes: a voltage-dividing unit dividing the output voltage from the step-up circuit unit to be provided to the comparison unit.

17. The charge pump circuit of claim 13, wherein the comparison unit includes:
a comparator comparing the output voltage from the step-up circuit unit with the first reference voltage; and
a digital block generating a control signal for controlling the regulating based on the comparison result from the comparator.

18. The charge pump circuit of claim 13, wherein the digital block generates the control signal for decreasing the output voltage from the regulator when the output voltage is higher than the first reference voltage and generates the control signal for increasing the output voltage from the regulator when the output voltage is lower than the first reference voltage.

19. The charge pump circuit of claim 13, wherein the regulator includes:
an operational amplifier including a non-inverting input terminal in which a predetermined second reference voltage is received;
a first resistor connected between an output terminal and an inverting input terminal of the operational amplifier; and
a second resistor connected between the inverting input terminal of the operational amplifier and ground.

20. The charge pump circuit of claim 19, wherein at least one of resistance values of the first and second resistors is altered according to the control signal.

21. The charge pump circuit of claim 19, wherein the regulator provides the voltage output from the operational amplifier to the level-inverting unit as a driving voltage.

22. The charge pump circuit of claim 19, wherein the regulator further includes a capacitor connected between the output terminal of the operational amplifier and ground so as to regulate the voltage output from the operational amplifier.
